(19) United States
(12) Patent Application Publication
(10) Pub. No.: US 2016/0061082 A1
(43) Pub. Date: Mar. 3, 2016

(54) CATALYST MODULE WITH CATALYST ELEMENTS

(71) Applicant: IBIDEN PORZELLANFABRIK FRAUENTHAL GMBH, Frauental an der Lassnitz (AT)

(72) Inventors: Kurt OREHOVSKY, Bad Badkersburg (AT); Michael AUMANN, Wien (AT); Andreas HARTUNG, Redwitz (DE); Thomas KRAINER, Graz (AT); Thomas NAGL, Schwechat (AT); Gerhard POELZL, Bad Gams (AT); Mario SCHWEIGER, Graz (AT)

(21) Appl. No.: 14/784,762

(22) PCT Filed: Apr. 14, 2014
(86) PCT No.: PCT/AT2014/000077

§ 371 Date: Oct. 15, 2015

(30) Foreign Application Priority Data
Apr. 15, 2013 (AT) A 306/2013

(51) Int. Cl. F01N 3/28; F01N 3/20; B01D 53/94

(52) U.S. Cl. CPC F01N 3/28; B01D 53/9431; F01N 3/2066; B01D 2255/9155

(57) ABSTRACT

The invention relates to a catalyst module with internal fittings made of catalyst elements, wherein the surface area of the individual catalyst elements, against which flow is directed, is greater than the flow entry surface area of the catalyst module, wherein the surface of the module side facing the main direction of flow is defined as the module entry surface, and wherein the catalyst elements in the catalyst module are positioned such that flue gas glows through said elements in a direction differing from the entry side and/or the exit side direction of flow.

### CROSS REFERENCE TO RELATED APPLICATIONS

This application is a U.S. National Phase Application under 35 U.S.C. §371 of International Patent Application No. PCT/AT2014/000077, filed Apr. 14, 2014, which claims the benefit of and priority to Austrian patent application No. A 306/2013, filed Apr. 15, 2013. The content of the above-noted patent applications are hereby expressly incorporated by reference into the detailed description hereof.

### FIELD OF THE INVENTION

The invention concerns a catalyst module with installed catalyst elements.

### BACKGROUND

SCR-catalysts represent the prior art for nitrogen removal from smoke gases. They provide a major contribution to decreasing the ozone near the ground, acid rain, and the greenhouse effect. This technology is employed in thermal power plants and garbage incinerators, as well as in internal combustion engines and many branches of industry.

Besides the reduction of nitrogen oxides, catalysts are also used for example in breaking down dioxins and furans, which has become the technical standard especially in garbage incinerators.

Catalyst elements are available for example in the form of homogeneously extruded honeycomb bodies or in the form of substrate materials whose surface is provided with a catalytic layer, and which are known as plate catalysts. Other embodiments are, for example, catalysts in pellet form, zeolite catalysts in which the active layer is applied to a ceramic substrate by the washcoat method, and also catalysts in the form of wavy plates.

For installation in SCR reactors, the individual catalyst elements are packaged in parallelepiped catalyst modules (such as steel modules), which taken together are called the catalyst layer. Between the individual catalyst modules and between the catalyst modules and the wall of the reactor housing holding the modules there are seals to force the flow of smoke gas through the catalyst elements.

A major performance indicator is the pressure loss resulting from the installation of the catalyst elements in the catalyst module. This unwanted pressure loss should be kept as low as possible. The pressure loss is influenced by the choice of the geometry of the catalyst elements, among other things. The choice of geometry, however, is subject to manufacturing as well as process limitations. The size of the SCR reactor also directly influences the pressure loss. Therefore, limits are placed on the design freedom: on the one hand, by construction restrictions, especially when SCR reactors are retrofitted afterwards, and on the other hand by economic considerations.

### SUMMARY

The problem which the invention proposes to solve is to provide catalyst modules with the largest possible catalytically active surface for given limited reactor cross section while at the same time minimizing the pressure loss caused by the catalyst elements. This problem is solved according to the invention in that the flow surface of the individual catalyst elements is larger than the flow inlet surface of the catalyst module, the module inlet surface being defined as the surface of the module side facing the main flow direction, and wherein the catalyst elements are positioned in the catalyst module such that the flow of smoke gas through them is different from the direction of the inlet and/or the outlet flow direction.

The providing of the required catalyst surface and the associated catalyst volume is thus accomplished by the arrangement of the catalyst elements inside the catalyst modules according to the invention, which results in greater depth of the catalyst modules. The cross section of the SCR reactor remains unchanged by this.

According to an alternative embodiment, catalyst elements are also preferably provided which undergo the flow of smoke gas parallel to the orientation of the inlet and/or outlet flow direction.

Preferably at least one smoke gas channel is arranged at the inlet side of the catalyst module, which leads the smoke gas into the catalyst module, the inlet side of the catalyst module being defined as the module side facing the main flow direction.

According to another feature of the invention, at least one smoke gas channel is arranged at the outlet side of the catalyst module, which leads the smoke gas out from the catalyst module, the outlet side of the catalyst module being defined as the module side away from the main flow direction.

### BRIEF DESCRIPTION OF THE DRAWING

FIG. 1 shows a conventional layout of a catalyst module.

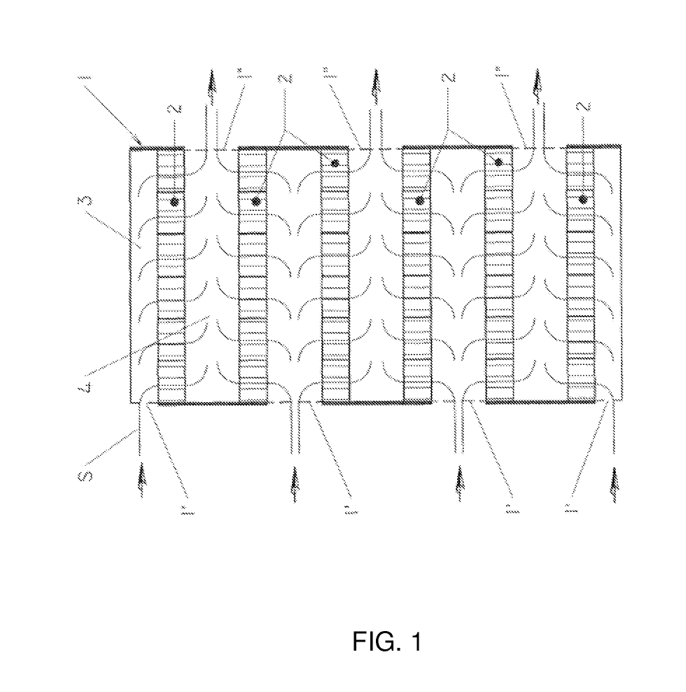

### DETAILED DESCRIPTION

The invention shall now be explained more closely making reference to the drawing, which shows a cross section through a catalyst module according to the invention.

The conventional layout of a catalyst module 1 is intended for the smoke gas flow S within the catalyst module 1 to go without deflection of the flow direction from the inlet side 1′ of the catalyst module 1 through the channels 3, 4 of the catalyst elements 2 to the outlet side 1″ of the catalyst module 1.

In the layout of the catalyst module 1 according to the invention, as represented in the figure, and being configured essentially as a closed parallelepiped body with rectangular side surfaces, the catalyst elements 2 have been repositioned differently from the former practice regarding the inlet side 1′ and/or the outlet side 1″ or the flow direction in the catalyst module 1. Thus, the flow through the catalyst elements 2 occurs in a direction differing from the inlet side and/or the outlet side flow direction, for example, offset by 90°. Thanks to this special arrangement of the catalyst elements 2 inside the catalyst module 1, it becomes possible to utilize the existing cross section of the reactor unit depthwise. In this way, any given scalability can be achieved.

The smoke gas is taken from the inlet side 1′ of the catalyst module 1 via several openings and several channels 3 to the catalyst elements 2. The catalyst elements 2 are arranged so that they are set off by 90° relative to the main flow direction S of the smoke gas at the module inlet side 1′. At the outlet side of each catalyst elements 2, the smoke gas again empties into a channel 4 by which the smoke gas is taken to the outlet side 1″ of the catalyst module 1.

The channels 3, 4 are open either to the inlet side 1′ or to the outlet side 1″ of the catalyst module 1, so that the smoke gas flow S is forcibly guided by the catalyst elements 2. The channels 3, 4 can optionally have a constant cross section, as shown in the sample, a narrowing or a widening cross section. The channels 3, 4 can also be optimized in regard to the flow conditions by streamlining installations.

By contrast, in the conventional layout of the catalyst modules 1 the supply of the smoke gas flow S to the catalyst elements 2 occurs directly at the inlet side 1′ of the catalyst module 1, because the catalyst elements 2 are usually arranged directly at the inlet side 1′ of the catalyst modules 1. In many variant configurations, statically relevant struts, load bearing points, walk-on gratings or the like are placed between the inlet side 1′ of the catalyst module 1 and the inlet to the catalyst elements 2, for example, which can result in a corresponding spacing between the inlet side 1′ of the catalyst module 1 and the inlet to the catalyst elements 2.

The above described invention can be used, for example:
to decrease the catalyst-caused pressure loss without changing the reactor cross section.
to decrease the catalyst-caused pressure loss while at the same time decreasing the reactor cross section.
to maintain the catalyst-caused pressure loss for a smaller reactor cross section.

Of course, the above described sample embodiment can take on different modifications within the notion of the invention, especially as regards the layer of the catalyst elements in the catalyst module.

What is claimed is:

1. A catalyst module having a flow inlet surface including installed catalyst elements having a flow surface, wherein the flow surface of the individual catalyst elements is larger than the flow inlet surface of the catalyst module, the module inlet surface being defined as the surface of the module side facing the main flow direction, and wherein the catalyst elements are positioned in the catalyst module such that the flow of smoke gas through them is different from the direction of the inlet and/or the outlet flow direction.

2. A catalyst module, having an inlet and/or outlet flow direction, comprising catalyst elements which undergo the flow of smoke gas parallel to the orientation of the inlet and/or outlet flow direction.

3. The catalyst module according to claim 1, wherein at least one smoke gas channel is arranged at an inlet side of the catalyst module, which leads the smoke gas into the catalyst module, the inlet side of the catalyst module being defined as the module side facing the main flow direction.

4. The catalyst module according to claim 1, wherein at least one smoke gas channel is arranged at an outlet side of the catalyst module, which leads the smoke gas out from the catalyst module, the outlet side of the catalyst module being defined as the module side away from the main flow direction.
